(19) United States
(12) Patent Application Publication
(10) Pub. No.: US 2013/0005553 A1
(43) Pub. Date: Jan. 3, 2013

(54) APPARATUS AND METHOD FOR BOW MAKING

(76) Inventor: Kari Mecca, Anaheim Hills, CA (US)

(21) Appl. No.: 13/364,239

(22) Filed: Feb. 1, 2012

Related U.S. Application Data
(60) Provisional application No. 61/438,954, filed on Feb. 2, 2011.

(51) Int. Cl. B31B 1/26

(52) U.S. Cl. 493/405

(57) ABSTRACT

Embodiments of the present invention provide a template for making decorative items out of ribbon or similar material. Moreover, other embodiments of the present invention include methods for using the template for making decorative items out of ribbon or similar material. In an embodiment of the invention, the decorative items are decorative flowers made of ribbon material.

### FIELD OF THE INVENTION

The present invention generally relates to articles and related methods for creating custom and decorative ornaments. More particularly, the present invention relates to an apparatus and method for making decorative items out of ribbon material.

### BACKGROUND OF THE INVENTION

In the sewing crafts, it is often desirable to make decorative ornaments out of ribbon material. Such decorative items can be used, for example, to adorn a dress or other clothing. In particular, especially for girls' or women's′ items, it can be desirable to adorn such items with decorative flowers made of ribbon or similar material. Premade decorative items can sometimes be purchased but sometimes at a significant cost. Also, selection may be limited with no ability to tailor such items to any particular need.

It is, therefore, desirable to have the ability to make custom-made decorative items. It is further desirable to provide an apparatus and method for simplified and rapid making of decorative items. It is further desirable to make decorative items that are consistent in certain characteristics such as size or texture.

The present invention achieves these and other characteristics as will be further described below.

### SUMMARY OF THE INVENTION

The present invention provides a template for making decorative items out of ribbon or similar material. Moreover, the present invention includes methods for using the template for making decorative items out of ribbon or similar material. In an embodiment of the invention, the decorative items are decorative flowers made of ribbon material.

### BRIEF DESCRIPTION OF THE DRAWINGS

The following drawings will be used to more fully describe embodiments of the present invention.

FIG. 1 is drawing of an apparatus according to a first embodiment of the present invention.

FIG. 2 is drawing of an apparatus according to an alternative embodiment of the present invention.

FIG. 3 illustrates a step of a method of a first embodiment of the present invention.

FIG. 4 illustrates a step of a method of a first embodiment of the present invention.

FIG. 5 illustrates a step of a method of a first embodiment of the present invention.

FIG. 6 illustrates a step of a method of a first embodiment of the present invention.

FIG. 7 illustrates a step of a method of a first embodiment of the present invention.

FIG. 8 illustrates a step of a method of a first embodiment of the present invention.

FIG. 9 illustrates a step of a method of a first embodiment of the present invention.

FIG. 10 illustrates a step of a method of an embodiment of the present invention.

FIG. 11 illustrates a step of a method of an embodiment of the present invention.

FIG. 12 illustrates a step of a method of an embodiment of the present invention.

FIG. 13 illustrates a step of a method of an embodiment of the present invention.

FIG. 14 illustrates a step of a method of an embodiment of the present invention.

FIG. 15 illustrates a step of a method of an embodiment of the present invention.

FIG. 16 illustrates a step of a method of an embodiment of the present invention.

FIG. 17 illustrates a step of a method of an embodiment of the present invention.

FIG. 18 illustrates a step of a method of an embodiment of the present invention.

FIG. 19 illustrates a step of a method of an embodiment of the present invention.

FIG. 20 is an illustration of a decorative flower made using an apparatus and method according to the present invention.

FIG. 21 illustrates a step of a method of an embodiment of the present invention.

FIG. 22 illustrates a step of an embodiment of a method of the present invention.

### DETAILED DESCRIPTION OF THE INVENTION

The following description is of certain preferred embodiments presently contemplated for carrying out this invention. This description is made for the purpose of illustrating the general principles of this invention and is not meant to limit the inventive concepts claimed herein.

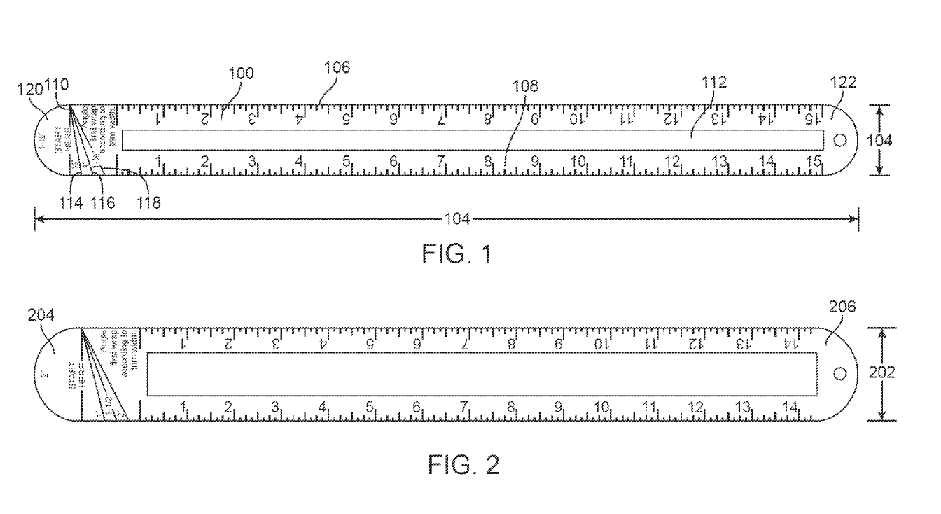

An embodiment of the invention is shown in FIG. 1. In an embodiment, template 100 is made of a smooth plastic or other material. As will be further described below, template 100 is preferably made of a smooth material so as to allow for the adhesion and removal of adhesive tape. Also, template 100 is preferably made of a smooth material so as to allow for the wrapping of ribbon or other material around template 100 without snagging. Moreover, template 100 is preferably made of a smooth material so as to allow ribbon or other material to be slid off of template 100 at certain steps of a method according to an embodiment of the invention.

In another embodiment of the invention, template 100 need not be made of a smooth material. For example, template 100 may be made of a roughened material so as to provide an appropriate amount of friction upon a ribbon or other material that may be wrapped around template 100.

In an embodiment of the invention, template 100 is made of a transparent or translucent material. Other materials can be used with different or varying degrees of opacity.

In an embodiment of the invention, template 100 includes a magnification region 112 that can be made of rounded and clear plastic so as to act as a magnification device. In another embodiment, region 112 is made to act as a Fresnel lens to provide magnification. An advantage of a Fresnel lens is that the thickness of template 100 can be made substantially the same throughout the width 104 of template 100.

In an embodiment, template 100 is made to have a thickness of 1/16 of an inch. In another embodiment, template 100 has a thickness of ⅛ of an inch.

As shown in FIG. 1, template 100 is made of an elongated plastic material having a length 102 and is further made having a first width 104. In the embodiment shown in FIG. 1, template 100 is made to be approximately 15 inches long and 1.5 inches wide. As shown template 100, includes optional rounded ends 120 and 124 that have a radius of curvature substantially similar to one-half of width 104. Template 100 is further made to have markings 108 that can be a scale such as a scale in inches or centimeters. Other scales may also be used.

Various lengths, widths, and thicknesses can be used for template 100 without deviating from the teachings of the present invention.

As further shown in FIG. 1, template 100 includes a marking 110 indicating a starting position for using template 100 according to a method of the present invention to be discussed further below. Also shown in template 100 are markings 114, 116, and 118 that are at distinct angles from marking 110. Among other things, markings 114, 116, and 118 are used according to a method of the present invention so as to provide consistent angles for wrapping of a ribbon or similar material. Markings 114, 116, and 118, therefore, lead to the making of consistent decorative items such as flowers. In an embodiment of the invention, markings 106 and 108 are made to complement markings 114, 116, and 118. For example, markings 106 can be made at an angle substantially similar to the angle of marking 114 as opposed to being perpendicular to the edge of template 100; similarly markings 106 can be made at an angle substantially similar to the angle of marking 116. In such an embodiment, where marking 114 is used in method of the present invention, markings 106 that are at substantially similar angle can be used to confirm that a consistent wrapping of a ribbon or other material is being made. Likewise, marking 116 could be used with angled markings 108 that can be made at a substantially similar angle.

FIG. 2 illustrates an alternative embodiment of the invention of template 200 that is made to have a different width 202. As shown, the width 202 is of approximately 2 inches. Accordingly rounded ends 204 and 206 have a radius of curvature that is substantially similar to width 202.

A method according to an embodiment of the invention for using template 100 will now be described to make decorative trim out of ribbon. In the methods to be described, it can be desirable to use ¼ inch or ½ inch rolls of a low tack or basic masking tape. It is preferred to test the tape on the ribbon or other material that will be used. Also, it is preferred to test the tape for appropriate adhesion to template 100. If a tape adheres to strongly, its tack can be reduced by multiple adhesions and removals on a clean surface.

In order to make extended lengths of trim, ribbon is wrapped around template 100 and tape is applied to hold the wrapped ribbon. Subsequently, template 100 is removed and the trim sewn according to a desired intermediate result such as sewn lengths of looped ribbon that can further be sewn in appropriate manners to make decorative flowers, for example.

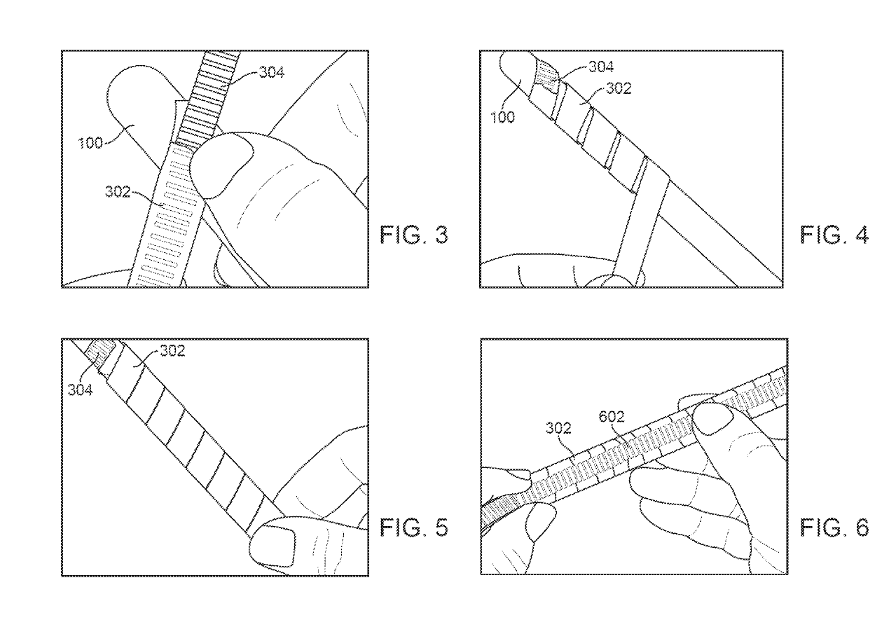

To be described now is a method according to an embodiment of the invention for using template 100 for making a single loop trim. As shown in FIG. 3, with ribbon 302 right side up, tape 304 is applied to the end of template 100 marked with marking 110 which is obscured by the ribbon in FIG. 3. Alternatively, ribbon 302 may be placed beside marking 110 in which case it would not be obscured. In an embodiment marking 100 can also be marked “Start Here.”

As shown in FIG. 4, ribbon 302 is wrapped around the length of template 100 leaving a spacing of about 1/16″ to ⅛″ space between wraps. In an embodiment of the invention, markings 114, 116, or 118 can be used to start the wrapping at an appropriate angle and markings 106 or 108 can be used to assure consistent wrapping and spacing of ribbon 302. For example, in an embodiment markings 106 or 108 can be made at the same or complementary angle as the angle of marking 110. To quickly wrap ribbon 302 around template 100, ribbon 302 can be held taut and template 100 can then be twisted so as to achieve the desired looped ribbon 302.

As shown in FIG. 5, wrapped ribbon 302 is pushed and adjusted so that ribbon 302 lays side-by-side and the wraps are smooth. Wrapping and smoothing is continued until substantially the entire length of template 100 is covered. Note that if the wraps of ribbon are made too tight, it may be difficult to remove the ribbon in subsequent steps.

As shown in FIG. 6, tape 602 is applied over the wraps of ribbon on both sides of template 100. In an alternative method, tape 602 is only applied on one side of template 100.

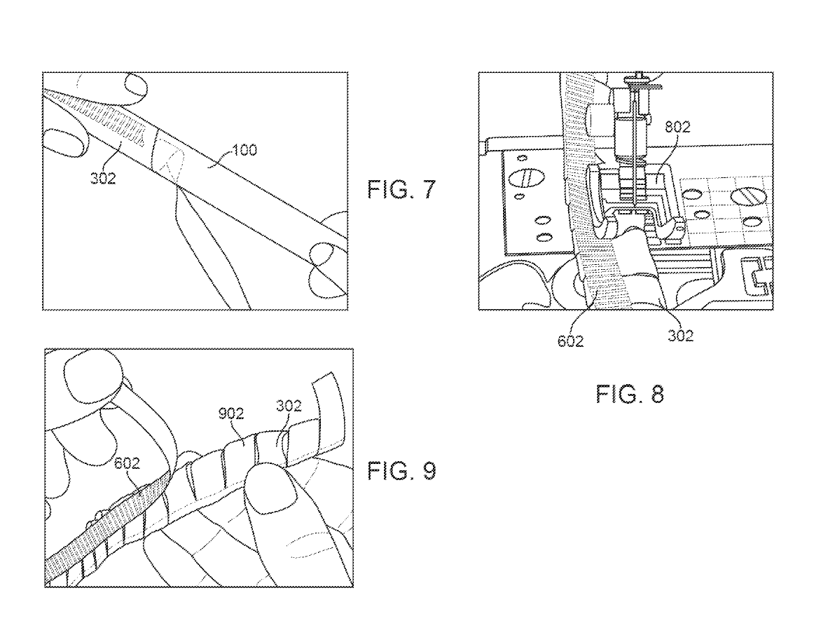

As shown in FIG. 7, tape 304 at the end of template 100 is removed and wrapped ribbon 302 is slid off of template 100. For lengths of trim longer than the length of template 100, it is preferred to leave several, for example, 3 or 4, taped wraps of ribbon 302 on template 100. In such a situation, wrapping and taping is continued in a similar manner as described with reference to FIGS. 4 through 7. When complete, further tape can be applied at the ends of wrapped ribbon 302 so as to maintain the positioning of ribbon 302.

As shown in FIG. 8, taped ribbon 302 is placed under presser foot 802 of a sewing machine. Taped ribbon 302 is then sewn close to one edge of wrapped ribbon 302 making sure that tape 602 is not sewn. In another embodiment, taped ribbon 302 is sewn over tape 602.

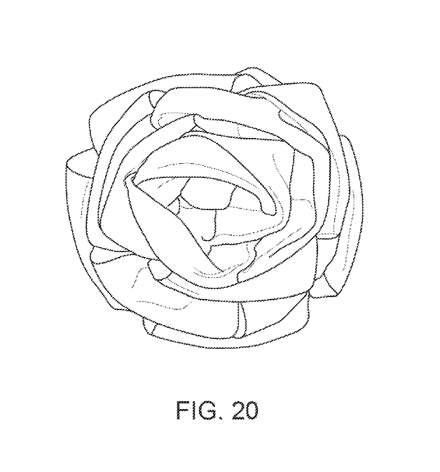

As shown in FIG. 9, tape 602 is removed after ribbon 302 is sewn. Note that if wrapped ribbon 302 is sewn over tape 602, care should be taken to remove small bits of tape that can become torn upon removing tape 602. At this stage, an extended length of looped trim 902 can be achieved that has consistent and attractive characteristics and can be further sewn in various ways to create decorative items. For example as shown in FIG. 20, looped trim 902 can be wrapped in a spiral fashion and affixed so as to make a decorative flower. Affixing of looped trim can be achieved by hand or through the use of a machine sewing. Affixing can also be achieved by application of adhesives such as hot glue as known to those of ordinary skill in the art.

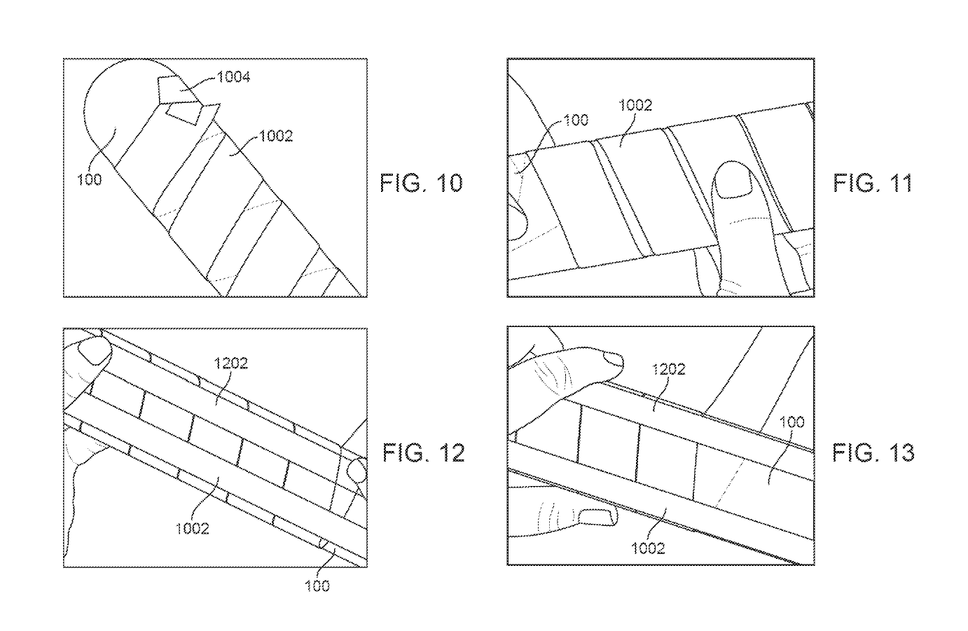

To be described now is the use of template 100 according to an embodiment of the invention so as to make double loop trim. As shown in FIG. 10, with ribbon 1002 right side up, tape 1004 is applied to the end of template 100 marked with marking 110. In an embodiment marking 100 can also be marked “Start Here.” As shown in FIG. 10 the width of template 100 is selected to be wider than as shown in FIG. 3. Correspondingly, ribbon 1002 is wrapped around the length of template 100 leaving approximately ⅛″ to ¼″ space between wraps.

As shown in FIG. 11, wrapped ribbon 1002 is pushed and adjusted so that ribbon 1002 lays side-by-side and the wraps are smooth. Wrapping and smoothing is continued until substantially the entire length of template 100 is covered. Note that if the wraps of ribbon are made too tight, it may be difficult to remove the ribbon in subsequent steps.

As shown in FIG. 12, tape 1202 is applied over the wraps of ribbon on both sides of template 100. In an alternative method, tape 1202 is only applied on one side of template 100.

As shown in FIG. 13, tape 1004 at the end of template 100 is removed and wrapped ribbon 1002 is slid off of template 100. For lengths of trim longer than the length of template 100, it is preferred to leave several, for example, 3 or 4, taped wraps of ribbon 1002 on template 100. In such a situation, wrapping and taping is continued in a similar manner as described with reference to FIGS. 11 through 13. When complete, further tape can be applied at the ends of wrapped ribbon 1002 so as to maintain the positioning of ribbon 1002.

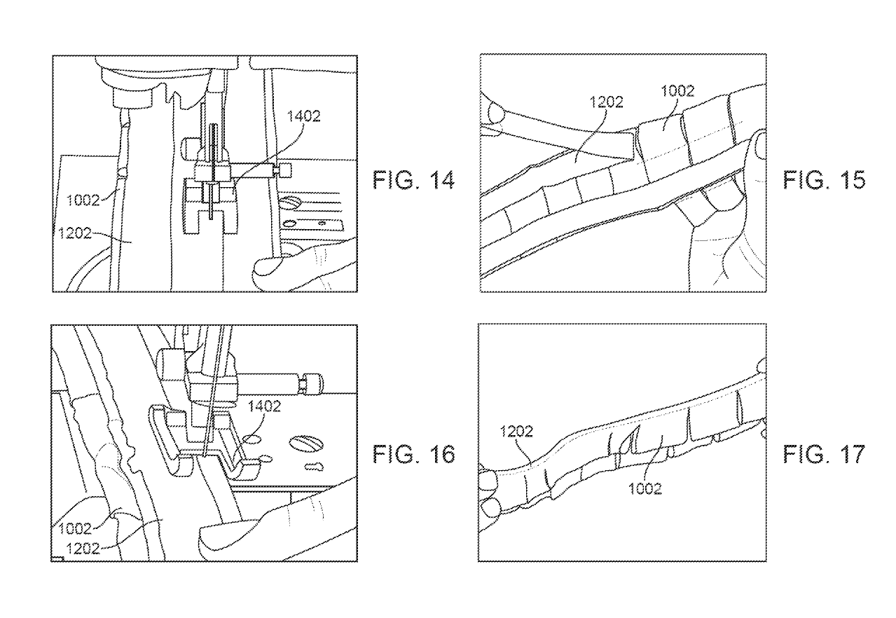

As shown in FIG. 14, taped ribbon 1002 is placed under presser foot 1402 of a sewing machine. Taped ribbon 1002 is then sewn down the center of taped ribbon 1002 making sure that tape 1202 is not sewn.

As shown in FIG. 15, tape 1202 is removed from one side of sewn ribbon 1002.

As shown in FIG. 16, the sewn loops of ribbon 1002 are folded in half with tape 1202 on the outside part of the fold. To achieve an aesthetic effect, the folding and loops can be offset slightly. The folded loops are then sewn close to the folded edge while not sewing tape 1202. In another embodiment, it can be desirable to sew over tape 1202, e.g., when using narrow width loops.

As shown in FIG. 17, the last portion of tape 1202 is removed from the finished loops.

At this stage, an extended length of looped trim 1702 can be achieved that has consistent and attractive characteristics and can be further sewn in various ways to create decorative items. For example as shown in FIG. 20, looped trim 1702 can be wrapped in a spiral fashion and affixed so as to make a decorative flower. Affixing of looped trim can be achieved by hand or machine sewing. Affixing can also be achieved by application of adhesives such as hot glue as well as other ways as known to those of ordinary skill in the art.

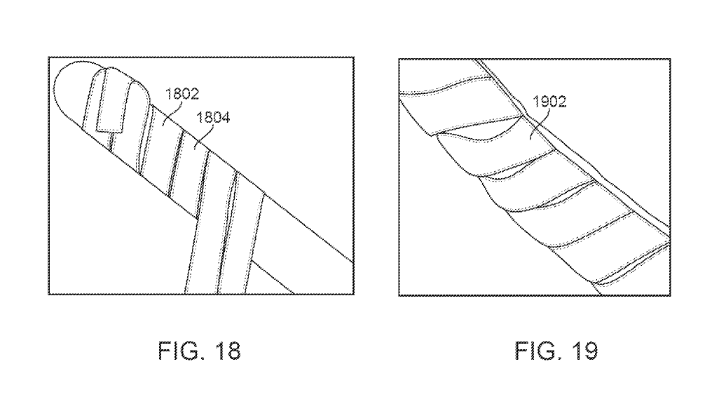

The method of the present invention can also be used with multiple strands of ribbon and, for aesthetic purposes, for example, can further be used with different colors of multiple strands of ribbon. For example, as shown in FIG. 18, ribbons 1802 and 1804 are positioned side-by-side and secured as describe previously. Ribbons 1802 and 1804 can then be wrapped as also described previously for the single loop method.

As shown in FIG. 19, looped ribbon 1902 is taped and sewn as described previously for the single loop method. Alternatively, ribbon 1802 can be taped and sewn according to the double loop method described previously.

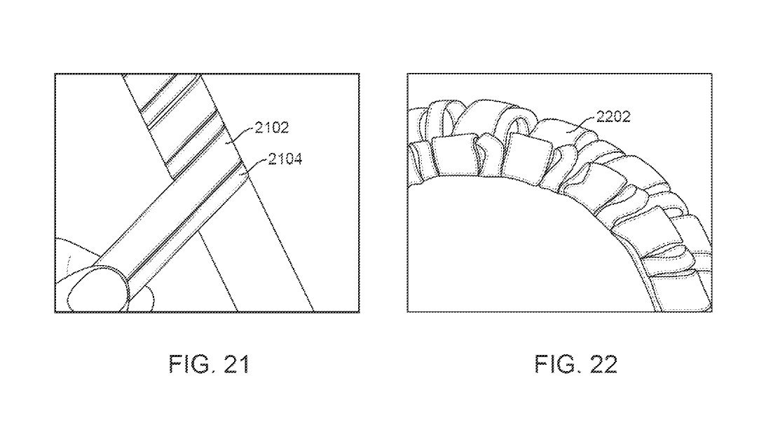

Likewise as shown in FIG. 21, ribbon 2101 and 2104 that have different widths can be used according to the present invention so as to achieve a fanciful looped trim 2202 as shown in FIG. 22.

It should be appreciated by those skilled in the art that the specific embodiments disclosed above may be readily utilized as a basis for modifying or designing other embodiments. For example, one of ordinary skill would readily understand that the present invention can be implemented using other materials. Also, one of skill in the art would understand that manner of spacing can be changed so as to achieve aesthetically pleasing results. It should also be appreciated by those skilled in the art that such modifications do not depart from the scope of the invention as set forth in the appended claims.

What is claimed is:

1. A template for making decorative trim, comprising:
a substrate having a length, a width, and a thickness, wherein the substrate is made of a rigid material;
a first marking at one end of the template so as to provide a starting point, wherein the first marking is substantially parallel to the width of the template and substantially perpendicular to the length of the substrate;
a second marking substantially close to the first marking, wherein the second marking is at a predetermined angle from the first marking and wherein the first and second markings have a vertex substantially close to an edge of the template along the length of the template.

2. The template of claim 1, wherein the substrate is substantially smooth.

3. The template of claim 1, wherein the substrate is substantially translucent.

4. The template of claim 1, further comprising a magnification region.

5. The template of claim 4, wherein the magnification region includes a longitudinal lens.

6. The template of claim 4, wherein the magnification region includes a Fresnel lens.

7. The template of claim 1, further comprising a third marking substantially close to the first marking, wherein the third marking is at a predetermined angle from the first marking that is different from the predetermined angle between the second marking and the first marking and wherein the first and third markings have a vertex substantially close to an edge of the template along the length of the template.

8. The template of claim 1, further comprising a first set of markings along the length of the substrate, wherein the first set of markings is at a predetermined angle from the first marking.

9. The template of claim 1, wherein the substrate further includes an end that is substantially round.

10. The template of claim 1, wherein the end has a radius of curvature of approximately ½ the width of the substrate.

11. A method for making ornaments, comprising:
providing a template made of a substrate having a length, a width, and a thickness, wherein the substrate is made of a rigid material, and wherein the template includes a first marking at one end of the template so as to provide a starting point, wherein the first marking is substantially parallel to the width of the template and substantially perpendicular to the length of the substrate, a wherein the template includes a second marking substantially close to the first marking, wherein the second marking is at a predetermined angle from the first marking and wherein the first and second markings have a vertex substantially close to an edge of the template along the length of the template;
adhering an end of at least one ribbon near the vertex of the first and second markings wherein the at least one ribbon is placed substantially along the direction of the second marking;
wrapping a length of the at least one ribbon around the width of the substrate and along the length of the substrate, wherein the at least one ribbon is positioned substantially edge-to-edge along windings of the at least one ribbon;
securing the wrapped length of at least one ribbon;
removing the wrapped length of the at least one ribbon form the template;
sewing together the wrapped length of the at least one ribbon along a length of the wrapped length of the at least one ribbon; and
positioning the sewed wrapped length of the at least one ribbon in a decorative manner.

12. The method of claim 11, wherein positioning is made by forming a spiral with the sewed wrapped length of the at least one ribbon.

13. The method of claim 12, wherein the positioning is fixed.

14. The method of claim 11, wherein positioning is made by forming undulations with the sewed wrapped length of the at least one ribbon.

15. The method of claim 11, wherein the at least one ribbon includes two ribbons of complementary aesthetic features.

16. The method of claim 11, wherein securing the wrapped length of at least one ribbon is made using a length of adhesive tape.

17. The method of claim 11, wherein adhering an end of at least one ribbon is made using a length of adhesive tape.

18. The method of claim 1, wherein wrapping a length of the at least one ribbon around the width of the substrate and along the length of the substrate is substantially taut.

19. The method of claim 1, wherein positioning the sewed wrapped length of the at least one ribbon is made in the form of a flower.
